(19) United States
(12) Patent Application Publication
(10) Pub. No.: US 2012/0198975 A1
(43) Pub. Date: Aug. 9, 2012

(54) Laser Indicator System

(76) Inventor: Scott A. Lindee, Mokena, IL (US)

(21) Appl. No.: 13/382,370

(22) PCT Filed: Jul. 7, 2010
(86) PCT No.: PCT/US10/41232

§ 371 Date: Apr. 24, 2012

Related U.S. Application Data
(60) Provisional application No. 61/223,486, filed on Jul. 7, 2009.

(51) Int. Cl. B26D 7/30; G01G 23/36; B26D 7/32

(52) U.S. Cl. 83/23; 83/73

(57) ABSTRACT

A weight correction system for a slicing apparatus includes a weigh scale that weighs a draft of slices output from a slicer, a laser device arranged above the drafts of slices from the slicer, and a control that assigns a weight to each draft of slices, compares the weight to a pre-selected acceptable weight and determines a correction indicator representative of the number of slices to be added to or subtracted from each draft. The control commands the laser device to project the correction indicator onto a top slice of the draft. The laser device can project the correction indicator onto the draft as the draft is moving on a conveyor, or the laser device projects the correction indicator onto the drafts when the drafts are stationary, such as when the drafts are stationary in a packaging station.

### FIELD OF THE INVENTION

The invention relates to a system used to monitor groups of food slices for correct weight.

### BACKGROUND OF THE INVENTION

In food processing, food product drafts can be a single food portion or a group of food portions such as a stack of slices. Food product drafts are sold according to a precise predetermined weight; under-weight drafts are rejected or supplemented with additional food slices and over-weight drafts are accepted but may represent an appreciable give-away and loss of revenue to the plant operator.

Even with advanced controls, the slicing machines and like food product machines that produce groups of food products cannot always maintain those groups within the present tolerance limit. To minimize waste, it is desirable to correct any out-of-tolerance or “reject” food product groups.

U.S. Pat. No. 5,109,936 to Ruppel describes a system that includes a slicing machine having a slicing blade and a feed mechanism, and uses feedback from primary and secondary weighing systems to control slice thickness in order to make proper weight. Another example is described in U.S. Pat. No. 3,846,958 to Divan. In this system, out-of-tolerance drafts are diverted to another location in order that an attendant may add or subtract product slices to make proper weight. Each of these patents is incorporated by reference herein. Common to all such systems is the fact that food products leaving the slicer are evaluated for weight and then slices of product are either added, or taken away to achieve an acceptable weight.

It has previously been proposed that excess product can be reintroduced into the system to supplement drafts that are under-weight and therefore minimize waste. One example of such a “makeweight” method is set forth in U.S. Pat. No. 5,499,719 to Lindee et al., which is hereby incorporated by reference herein. This system uses a standalone take away and correction conveyor system for a food loaf slicer or other food product machine that produces groups of food products that must be held to close tolerance as to weight or some other readily measurable characteristics. There are two conveyors, one for reject groups and one for acceptable groups. The two conveyors are mounted on one base, spaced parallel in relation to each other, with the reject conveyor above the accept conveyor. A correction tray is used for correction of reject groups of food products. The correction tray is positioned adjacent to the reject and accept conveyors, so that an operator can divert reject groups from the reject conveyor to the correction receptacle, correct the reject groups at the correction receptacle to form acceptable groups therefrom, and deposit the corrected acceptable groups on the accept conveyor.

Back bacon off-weight rejects from the Formax SNS® slicer are typically transferred to a conveyor at 90 degrees to the slicer. These reject stacks are manually taken off the conveyor and placed on a freestanding scale. The scale operator will add or remove slices to the rejected stacks in order to make an acceptable on-weight portion. These stacks are then hand-carried to the end of the slicing line in order to be manually introduced into the packaging machine.

The present inventor has recognized this method is labor intensive.

The present inventor has also recognized the desirability of providing a more efficient method for correcting weight of packaged food products.

### SUMMARY OF THE INVENTION

The invention provides and exemplary method of correcting the weight of portions produced by a machine, the portions being carried by a conveyor away from the machine. The method includes the steps of: transporting a portion on a conveyor away from the machine; weighing the portion and determining a deviation corresponding to an amount the portion is over or under a pre-selected weight; projecting an image onto the portion that represents the deviation; and making a correction to the amount of the portion that corresponds to the deviation.

Preferably, the image is projected onto the portion while the portion is moving on the conveyor and the image moves with the portion.

Alternately, the image is projected onto the portion while the portion is moving on the conveyor and the image does not move with the portion. The portion in effect moves through the image.

Alternately, the image is projected onto the portion while the portion is stopped on the conveyor. This can occur in the packaging area.

As an enhancement, a sensing whether the step of making a correction has been completed can occur and, if the step of making a correction has been completed, the image can be automatically turned off.

Advantageously, the portion is a collection of slices and the machine is a slicing machine. The step of making a correction is further defined as adding a slice to or subtracting a slice from the collection. This can be done manually by a worker observing the laser image on the collection and adding a slice to or removing a slice from the collection.

The invention provides a method of identifying under-weight and over-weight groups of food slices in order to manually correct the groups.

The present invention provides a laser indicator system that can be used with a conveyor system, such as for a food slicing machine. Once a group of food slices is collected onto a conveyor as a draft and weighed, a laser image follows the food group and indicates whether the food group is under-weight or over-weight by illuminating a number on the top slice of the food group (0, −1, +1, etc.). If a food group is under-weight, the laser will specify how many slices are needed to make the food group make the correct, acceptable weight. If the food group is over-weight, the laser will specify how many slices need to be taken off to make correct weight without being unduly overweight, which constitutes “giveaway.” Once the under-weight or over-weight food group makes correct weight, this information can be fed back to the laser indicator system whereupon the system turns the laser off of this food group. The laser will then be reset to a home position to follow another group of food slices and indicate whether that food group is of sufficient weight, under-weight, or over-weight.

Multiple laser devices can be used to simultaneously track multiple food slice groups or drafts, such as one laser for each lane of food groups carried on a multilane conveyor. Alternately, a single laser device can be provided for each column or lane of drafts that are carried on the conveyor.

Alternately, the laser can project the slice correction indication in the packaging area. The indication can be directed onto the product after it has been placed into the packaging. In order to project the correct indication on the product, the control system tracks the product from the weigh scale to the packaging so that the correct indication can be projected onto the underweight or overweight stack or draft as loaded into the packaging array.

If there is a dwell period wherein the entire array that is filled in the packaging station is stationary in the packaging station, the slice correction can be made to all stacks in the array during the dwell period. Alternately, the slice correction can be made while the packaging is indexed row by row at the packaging station.

The components of the food slicing machine (input scale, slicing mechanism, output scale, etc.) can be similar to that in U.S. Pat. No. 5,628,237 or U.S. patent application Ser. No. 12/255,634 filed Oct. 21, 2008 or any variation thereof, these references being incorporated by reference herein. The laser in this system can be similar to that in U.S. Pat. Nos. 7,336,686; 6,874,893; 7,440,590; 7,408,558 or any variation thereof and are incorporated by reference therein. The laser indicator system is not limited to one laser; rather more than one laser can be used in the system.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is an elevation view of a conveyor system and slicer incorporating the invention; and

FIG. 2 is a plan view of the conveyor system and slicer of FIG. 1.

FIG. 3 is an elevation view of another embodiment of the conveyor system and slicer of the present invention.

FIG. 4 is a top view of a packaging location of the present invention.

### DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

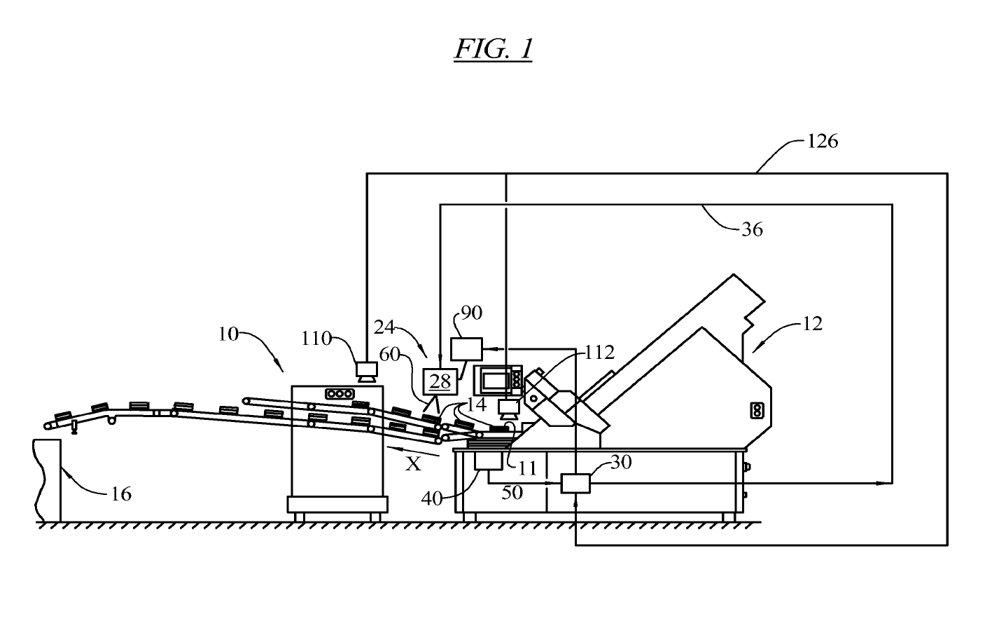

FIG. 1 is a side elevation view of a conveyor system 10 fed sliced products 11 by a food slicing machine 12, such as a FX180® or PowerMax 4000™ slicer from Formax, Inc. of Mokena, Ill., USA.

The slices 11 are collected on the conveyor system 10 as a stacked draft, shingled draft or loose draft 14 that are translated in the direction “X” on a conveyor surface 15 toward a packaging station 16.

A laser indicator system 24 contains at least one laser device 28 that communicates with a food slicing machine control unit 30 via a signal carrier, such as a cable 36.

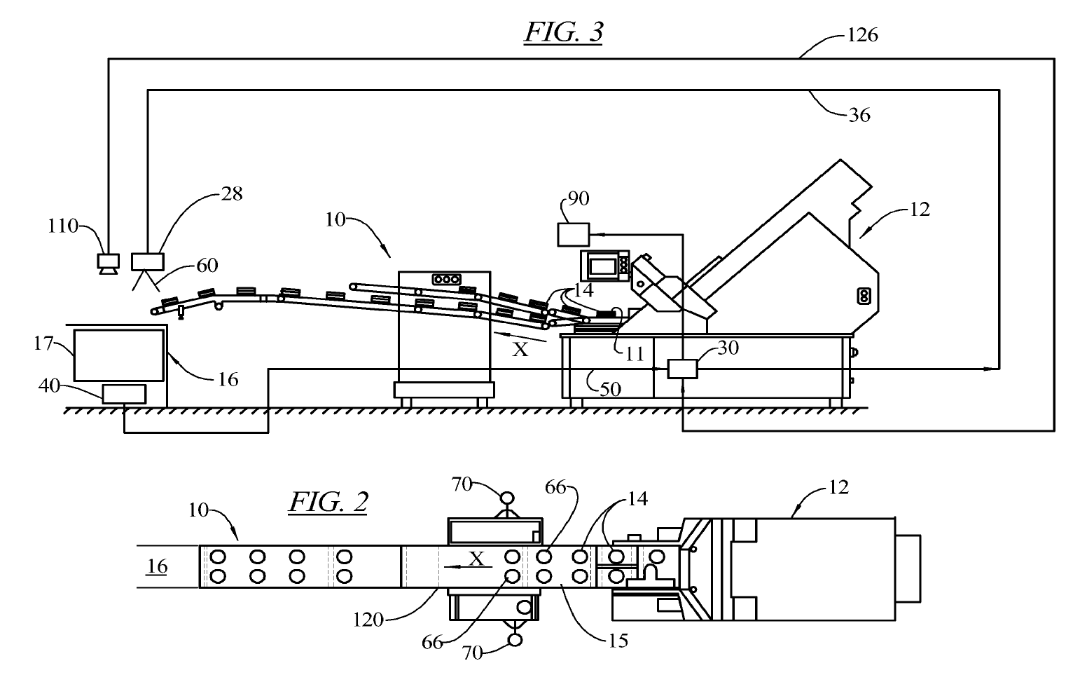

FIG. 2 is a plan view of the conveyor system 10 and the food slicing machine 12. Once a draft 14 of food slices 11 is collected on the conveyor it passes over a weigh scale 40, and the weigh scale 40 measures the weight of the draft and communicates the weight to the control 30. The weigh scale 40 conveys the weight information of each draft to the control unit 30 via a signal carrier, such as a cable 50. The control unit 30 calculates the number of slices that need to be added or removed for that particular draft to make correct weight. In this regard the control unit 30 has a predetermined slice weight in memory. The control unit 30 conveys this information to the laser indicator system 24, which then directs a laser beam 60 that illuminates the corresponding number (0, −1, +1, etc.) image 66 on the top slice of the food draft. If the weight is satisfactory the displayed number can be “0” or no indication at all. The laser indicator system 24 tracks the draft 14 until further information commands the laser device 28 to turn off the beam 60 displayed on that draft.

To track the draft 14 as it is transported on the conveying surface 15, the beam 60 must either be translated with the draft at a similar speed as it is transported in the direction “X”, or must be tilted as the drafts 14 are transported such as to always display the correction number on that draft. A laser tracking actuator 90 can comprise: a translating mechanism that moves the laser device 28 along the direction “X”; or a tilting mechanism that progressively tilts the laser device 28 (clockwise in FIG. 1) to maintain the image 66 on the draft as it moves along the conveyor in the direction “X.” In either case, after a limited amount of travel of the draft, the actuator 90 must reset the laser device 28 to a home position to track a subsequent draft. The control 30 has as an input the speed of the conveying surface and the location of each completed draft on the conveying surface. This information is communicated to the laser system 24 particularly to the actuator 90.

Accordingly, a worker 70 is informed as to the number of slices required to be added or removed from a draft to make correct weight for that draft. The worker 70 can then add or remove a slice or slices from the drafts 14 displaying the particular number image 66 generated by the laser indicator system 24 as the drafts are moving on the conveyor.

As an enhancement, once the appropriate slices have been added or deleted, the laser indicator system is turned off for that food group and such food group continues down the conveyor to the packaging unit. The laser indicator system can be automatically turned off and reset to a home position when the correction is made by one or a combination of the following examples:

(1) the laser indicator senses an optical interruption of the laser path by the addition or removal of a slice or slices; or

(2) a camera 110 senses the face of a new top slice compared to the face of a prior top slice sensed by a camera 112, caused either by the addition or removal of a slice or slices, on the top of the draft; or

(3) the laser device senses the draft has reached a certain point 120 on the conveyor.

The cameras 110, 112 may be incorporated into the laser indicator system 24 or may stand alone. The camera 110 can communicate directly with the laser indicator system 24 to reset the laser indicator system 24 after a draft is adjusted or the cameras 110, 112 can communicate with the unit 30 via a signal carrier, such as a cable 126, which will then communicate that the adjustment has occurred to the laser indicator system 24 via the signal carrier 36 to reset the laser device 28.

The laser indicator system does not need to divert “reject” groups to a separate location, nor does it need an additional conveyor in order to separate “reject” groups from groups that have made proper weight. As a result, the use of a laser to track groups of food slices permits “reject” groups to be identified and corrected by workers as the groups are moving toward the packaging station. The groups need not be stopped or redirected and weight correction can be made in a faster and more efficient manner than prior systems.

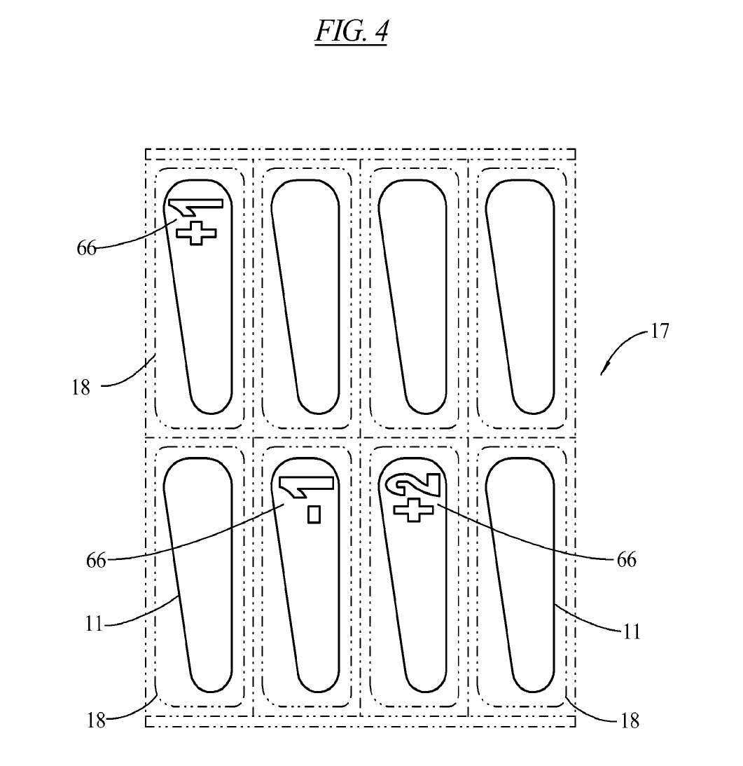

A second embodiment is shown in FIGS. 3 and 4. Slicing machine 12 incorporates similar features, including a conveyor surface 15, control unit 30, and a laser device 28. Food slices 11 are fed to the conveyor surface 15 from a slicing system. When the food slices 11 reach the end of conveyor surface 15, they are transferred onto a declined loading conveyor surface 15a which loads the drafts into a packaging array 17 of trays 18 at the packaging station 16.

The arrays 17 of trays 18 are formed successively in a continuous web 19 of packaging film upstream of the packaging station 16. The web 19 is pulled to the left in FIG. 3 to move arrays 17 through the packaging station 16. The arrays 17 are filled, either during a dwell period as upstream trays are being formed, as the array 17 is stationary in the packaging station, or filled row-by-row in index fashion as the array 17 enters the packaging station. The packaging array 17 moves longitudinally, with respect to conveyor surface 15a, so drafts 14 of food slices 11 being transferred on conveyor surface 15a fall into trays 18.

Methods of filling trays are described in U.S. Pat. No. 7,065,936, herein incorporated by reference.

A top view of food packaging 17 is shown in FIG. 4. Food packaging is shown with eight trays 18 to hold food slices 11 therein. Example images 66 of “+1,” “−1,” and “+2” projected onto the top slice of each draft 14 are shown.

According to this embodiment, laser device 28 is located at the packaging station. An image 66 is projected onto the surface of the top food slice 11 by the laser device 28. A worker 70 is present at the location of the packaging station 16, to add or remove the required amount of food slices 11 according to the instruction of the image 66. When the adjustment is made, a camera 110, timer, or other apparatus, may be used to signal the correction has been made and turns off the display 66 from the laser device 28.

Because the packaging station is spaced downstream from the weigh scale 40, the system control 30 must “track” the drafts so that the correct indication of stack underweight or overweight is projected on the stack or draft at the packaging station 16.

The laser or lasers can be configured to project an image onto the draft that follows the movement of the draft on the conveyor. Alternately, the draft can be moved through the laser projection wherein the laser doesn't follow the draft. In that case the image would only briefly be viewable on the draft as the draft is moved through the stationary laser projection. Alternately, the draft can be stopped on the conveyor and the image projected onto the draft from a laser that projects a stationary laser projection, i.e., the projection does not follow or track a moving draft.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A weight correction system for a slicing apparatus comprising:
a weigh scale that weighs a draft output from a slicer;
a laser device arranged above the drafts of slices from the slicer, configured to project a laser image corresponding to a correction indicator downward;
a control that assigns a weight to the draft, compares the weight to a pre-selected acceptable weight and determines the correction indicator representative of the amount to be added to or subtracted from the draft, and the control commanding the laser device to project the laser image onto the draft.

2. The system according to claim 1, wherein the laser device projects the correction indicator onto the draft as the draft is moving on a conveyor, the laser device tracking the movement of the draft to maintain the laser image onto the draft.

3. The system according to claim 1, wherein the laser device projects the laser image onto the draft when the draft is stationary.

4. The system according to claim 1, wherein the laser device projects the laser image onto the drafts when the draft is stationary in a packaging station.

5. The system according to claim 1, wherein the laser device projects the laser image onto the draft as the draft is moving on a conveyor, the laser device tracking the movement of the draft to maintain the laser image onto the draft, wherein the laser device projects the laser image onto the draft when the draft is stationary in a packaging station.

6. The system according to claim 5, comprising a sensor that senses that the weight assigned to the draft has been changed from an amount either added to or subtracted from the draft, and sends this information to the control whereupon the control turns the laser image off of the draft.

7. The system according to claim 1, comprising a sensor that senses that the weight assigned to the draft has been changed from an amount either added to or subtracted from the draft, and sends this information to the control whereupon the control turns the laser image off of the draft.

8. The system according to claim 1, wherein the draft comprises a collection of slices and the correction indicator corresponds to a number of slices to be added to or removed from the draft.

9. The system according to claim 8, comprising a sensor that senses that the slice has been added to or removed from the draft, and sends this information to the control whereupon the control turns the laser image off of the draft.

10. A method of correcting the weight of portions produced by a machine, wherein the portions are carried by a conveyor away from the machine, comprising the steps of:
transporting a portion on a conveyor away from the machine;
weighing the portion and determining a deviation corresponding to an amount the portion is over or under a pre-selected weight;
projecting an image onto the portion that represents the deviation;
making a correction to the amount of the portion that corresponds to the deviation.

11. The method according to claim 10, wherein the step of projecting the image onto the portion occurs while the portion is moving on the conveyor and the image moves with the portion.

12. The method according to claim 10, wherein the step of projecting the image onto the portion occurs while the portion is moving on the conveyor and the image does not move with the portion.

13. The method according to claim 10, wherein the step of projecting the image onto the portion occurs while the portion is stopped on the conveyor.

14. The method according to claim 10, comprising the further step of sensing whether the step of making a correction has been completed and, if the step of making a correction has been completed, turning off the image.

15. The method according to claim 10, wherein the portion is a collection of slices and the machine is a slicing machine, and the step of making a correction is further defined as adding a slice to or subtracting a slice from the collection.

16. The method according to claim 15, wherein the step of projecting the image onto the collection occurs while the collection is moving on the conveyor and the image moves with the collection.

17. The method according to claim 16, comprising the further step of sensing whether the step of making a correction has been completed and, if the step of making a correction has been completed, turning off the image.

18. The method according to claim 15, wherein the step of projecting the image onto the collection occurs while the collection is moving on the conveyor and the image does not move with the collection.

19. The method according to claim 15, wherein the step of projecting the image onto the collection occurs while the collection is stopped on the conveyor.

20. The method according to claim 15, comprising the further step of sensing whether the step of making a correction has been completed and, if the step of making a correction has been completed, turning off the image.
